(19) United States
(12) Patent Application Publication
(10) Pub. No.: US 2004/0228686 A1
(43) Pub. Date: Nov. 18, 2004

(54) Sump for fuel dispenser

(76) Inventor: Luis Argandona, Duarte, CA (US)

Correspondence Address: Boniard I. Brown, #113, 1500 West Covina Parkway, West Covina, CA, 91790-2793, US

(21) Appl. No.: 10/439,944

(22) Filed: May 16, 2003

(51) Int. Cl. E02B 13/00; B67C 3/02

(52) U.S. Cl. 405/52; 137/312; 141/86

(57) ABSTRACT

A sump for installation generally under a fuel dispenser, has at least one upwardly extending access riser having an opening with an edge flush with a dispenser supporting surface. Two access risers may be provided, one spaced adjacent to a fuel dispenser, and the other disposed generally beneath the fuel dispenser. Sumps according to the invention provide ready access to electrical and mechanical components for inspection and repair, and eliminate any necessity for breaking up concrete surfaces or structures, or for removal of a dispenser and replacement thereof to access components in a sump.

### BACKGROUND AND SUMMARY OF THE INVENTION

Filling stations typically use sumps to collect any spilled gasoline or other fuel, and to house mechanical components, fittings, and electrical components. Sumps are generally disposed adjacent to and below the fuel dispensers.

Filling stations generally do not provide for access to the sump interior for inspection, repair of components therein, etc. It is often necessary to break up the concrete of an island supporting a dispenser in order to gain access to sump contents. The broken concrete must be replaced and repaired. It is often necessary to completely remove a fuel dispenser for access to the sump interior, and then later return it to its position and secure it in place.

The present invention provides a sump which is adapted to be disposed generally adjacent to a fuel dispenser, and which is adapted to contain fuel leaked from the dispenser. A first access riser extends vertically, and has an upper opening with its edge substantially flush with an island surface or other surface supporting the dispenser. A second access riser is spaced from the first riser and positioned below the dispenser, and has an upper opening with an edge flush with the surface supporting the dispenser. The access riser openings give good access to the sump interior for inspection and repair.

### BRIEF DESCRIPTION OF THE DRAWINGS

FIG. 1 is an elevational view, partially in section, showing a sump according to the present invention in relation to a fuel dispenser; and

FIG. 2 is a perspective view of a sump of FIG. 1, showing a cover member utilized therewith.

### DESCRIPTION OF THE PREFERRED EMBODIMENT

The present invention provides an improved dispenser containment sump which provides ease of access for inspection and repair of electrical and mechanical components in the sump below a fuel dispenser.

Relatively easy access is provided, in contrast with prior art sump arrangements which often require the breaking up of concrete islands, etc. and/or removal and replacement of a fuel dispenser to gain access to mechanical and electrical components in the sump.

Referring to the drawings, the sump or sump containment structure 10 according to the invention comprises a first access riser 12, a removable cover 14 thereon, a larger access riser or funnel 16, a lower body portion 18, and an inclined bottom wall 20.

A dispenser 22 generally sits atop an island 24, typically formed of concrete and disposed atop a grade or road surface 30. The thickness or height of the island may vary among different installations.

A nozzle 32 or a plurality of nozzles, is supported by a hanger 34 and connected by a hose 36 to the interior system of the dispenser. The dispenser is secured to the island by anchor bolts 26. It is preferred that the dispenser bottom rests directly on the island, because if it does not, a sizable crack or opening is presented, which detracts from the dispenser appearance.

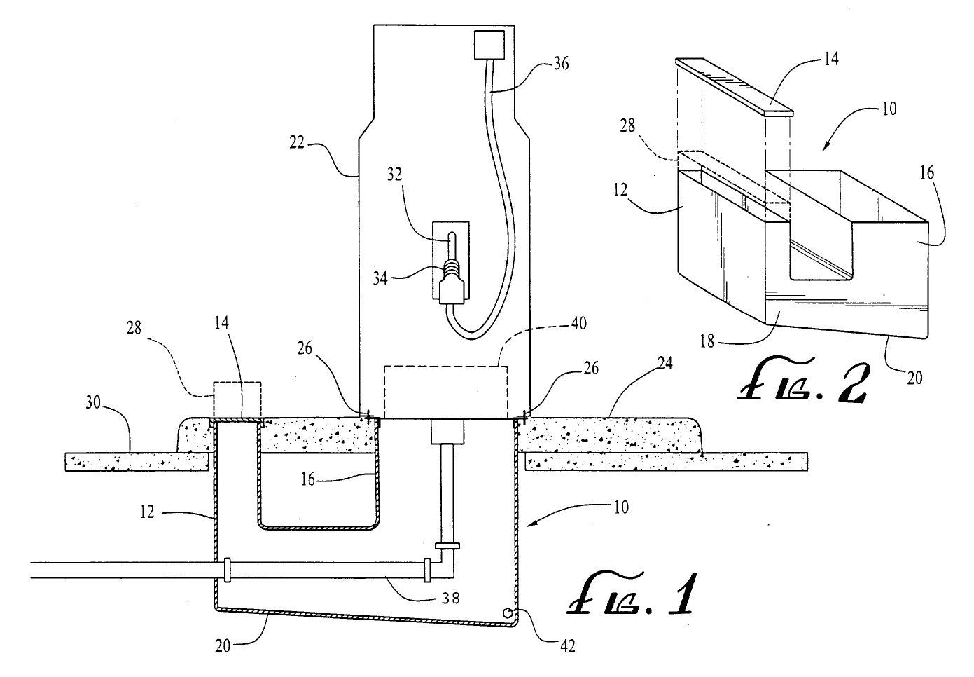

The containment sump is mounted as shown in FIG. 1 wherein the first access riser 12 extends upwardly through the island 24 and has its upper edge flush with the upper surface of the island. The second access riser 16 extends generally under the dispenser 22 and has its upper edge flush with the island surface.

Referring to FIG. 1, the bottom wall 20 of the sump is inclined from the horizontal to a significant degree, in order that any gasoline or fuel leaked into the sump will gravitate to the lower right of the sump, where a sensor 42 is mounted. The sensor is connected with circuitry which energizes a signal device or other indication that fuel has leaked into the sump. It is preferable that the bottom surface be free of irregular formations and that it be flat, in order that any gasoline or other fuel disposed in the bottom of the sump not be retained and will pass directly to the sensor 42.

In installing the sump, it is positioned in an opening in the ground with the access risers extending upwardly. The sumps typically have risers of sufficient height that they can be cut to a size appropriate for a particular installation. The sumps are typically formed of fiberglass or the like, so that they may be cut at the site of installation of the sump, and the sump access risers may be cut to such height that the upper edges of the access riser are flush with the island 24. A removed portion of access riser 12 is shown in broken lines at 28 in FIGS. 1 and 2.

An access door 40 is provided on the dispenser to facilitate access to the interior of the second containment riser 16.

Greatly improved access is provided by the sump of the invention for inspection and repair of electrical components (not shown) and mechanical or hydraulic components, as indicated at 38 (FIG. 1). Many prior sumps do not provide ready or convenient access for repair and inspection to electrical and mechanical components disposed in the sump. Thus, if a test fails and/or repairs are necessary, the dispenser must be removed and later replaced in position, and often concrete must be broken away from the island, etc. to gain access to the sump interior for necessary repairs and replacement. Because it is legally required that tests of the equipment be conducted at least every three years, the present invention provides a desirable and economical approach to the inspection, testing,repair and replacement of components disposed in filling station sumps.

It will be understood that various changes and modifications may be made from the preferred embodiment discussed above without departing from the scope of the present invention, which is established by the following claims and equivalents thereof.

The inventor claims:

1. A containment sump for installation at a fuel dispenser, comprising:
a sump housing configurated and adapted to be disposed generally adjacent a fuel dispenser,
said sump being adapted to contain liquid leaking from the dispenser, and
said sump having at least one access riser extending generally vertically and having an upper opening edge substantially flush with a surface supporting the dispenser,
whereby access to mechanical and electrical components in the sump are accessible via said at least one access riser.

2. A sump according to claim 1, wherein said surface is on an island whereon the dispenser is disposed above a grade level of an adjacent driveway.

3. A sump according to claim 1, wherein said island is formed of concrete.

4. A containment sump according to claim 1, and further comprising a second access riser spaced from said first riser.

5. A sump according to claim 1, wherein the sump is formed of material adapted to be cut to define an access riser upper edge flush with said dispenser supporting surface.

6. A sump according to claim 1, wherein said fuel dispenser dispenses (a) gasoline, (b) diesel fuel.

7. A sump according to claim 1, and further comprising a second access riser spaced from the first riser and disposed generally below the fuel dispenser.

8. A containment sump according to claim 1, and further comprising a cover for closure of the sump interior.

9. A sump according to claim 1, wherein the sump is formed of material adapted to be cut to define an access riser upper edge flush with said dispenser supporting surface.

10. A sump according to claim 9, wherein the sump is formed of fiberglass.

11. A sump according to claim 1, wherein the bottom wall of the sump is inclined from the horizontal to cause fuel or liquid leaked into the sump to gravitate to the lower side of the sump to engage a sensor to provide indication of leakage into the sump.

12. A containment sump for installation at a fuel dispenser, comprising:
a sump housing configurated and adapted to be disposed generally adjacent a fuel dispenser, said sump being adapted to contain liquid leaking from the dispenser,
a first access riser extending generally vertically and having an upper opening flush with a surface supporting the dispenser, and
a second access riser extending generally vertically and having an upper opening substantially under the dispenser,
whereby access to mechanical and electrical components in the sump is provided via said at least one access riser.

13. A sump according to claim 12, wherein said surface is on an island whereon the dispenser is disposed above a grade level of an adjacent driveway.

14. A sump according to claim 12, wherein said island is formed of concrete.

15. A sump according to claim 12, wherein the sump is formed of material adapted to be cut to define an access riser upper edge flush with said dispenser supporting surface.

16. A sump according to claim 15, wherein the sump is formed of fiberglass.

17. A sump according to claim 12, wherein the bottom wall of the sump is inclined from the horizontal to cause fuel or liquid leaked into the sump to gravitate to the lower side of the sump to engage a sensor to provide indication of leakage into the sump.
